(19) United States
(12) Patent Application Publication
(10) Pub. No.: US 2005/0278693 A1
(43) Pub. Date: Dec. 15, 2005

(54) Distribution adaptor for network management application development

(76) Inventors: Edward G. Brunell, Chicago, IL (US); Kwok-Chien Choy, Wayne, NJ (US); Shankar Krishnamoorthy, Scotch Plains, NJ (US); Xiangyang Shen, Naperville, IL (US); Manjula Sridhar, Lisle, IL (US); Dong Zhao, Lisle, IL (US)

Correspondence Address: Richard J. Minnich, Esq.;Fay, Sharpe, Fagan, Minnich & McKee, LLP, 1100 Superior Avenue, Seventh Floor, Cleveland, OH, 44114-2518, US

(21) Appl. No.: 10/868,656

(22) Filed: Jun. 15, 2004

(51) Int. Cl. G06F 9/44

(52) U.S. Cl. 717/106; 717/114

(57) ABSTRACT

Methods of developing an application program to manage a distributed system or network is provided. In one embodiment, the method includes: a) defining managed objects in a resource definition language and storing the definition in resource definition language files, b) parsing the resource definition language files to ensure conformity with the resource definition language and creating an intermediate representation of the distributed system, c) processing the intermediate representation to form programming language classes, database definition files, and script files, d) providing a reusable asset center framework to facilitate development of the application program, the reusable asset center including a distribution adaptor framework that provides each application program with distribution transparency for remote and local operations, and e) building the application program from the programming language classes, database definition files, script files, and the reusable asset framework.

### CROSS-REFERENCE TO RELATED APPLICATIONS

This application is related to Zhao et al., Attorney Docket No. LUTZ 2 00268 and Lucent Case Name/No. Brunell 1-1-1-1-1, entitled “Run-Time Tool for Network Management Application,” filed Jun. 15, 2004, commonly assigned to Lucent Technologies, Inc. and incorporated by reference herein.

This application is related to Sridner et al., Attorney Docket No. LUTZ 2 00289 and Lucent Case Name/No. Brunell 2-2-2-2-2, entitled “Resource Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00324 and Lucent Case Name/No. Brunell 3-3-3-3-3, entitled “View Definition Language for Network Management Application Development,” filed Jun. 15, 2004, commonly assigned to Lucent Technologies, Inc. and incorporated by reference herein.

This application is related to Zhao et al., Attorney Docket No. LUTZ 2 00325 and Lucent Case Name/No. Brunell 5-2-5-5-5, entitled “Event Management Framework for Network Management Application Development,” filed Jun. 15, 2004, commonly assigned to Lucent Technologies, Inc. and incorporated by reference herein.

This application is related to Sridner et al., Attorney Docket No. LUTZ 2 00326 and Lucent Case Name/No. Brunell 6-1-6-5-6-6, entitled “Managed Object Framework for Network Management Application Development,” filed Jun. 15, 2004, commonly assigned to Lucent Technologies, Inc. and incorporated by reference herein.

This application is related to Shen et al., Attorney Docket No. LUTZ 2 00327 and Lucent Case Name/No. Brunell 7-7-6-7-7, entitled “Data Management and Persistence Frameworks for Network Management Application Development,” filed Jun. 15, 2004, commonly assigned to Lucent Technologies, Inc. and incorporated by reference herein.

This application is related to Sridner et al., Attorney Docket No. LUTZ 2 00328 and Lucent Case Name/No. Brunell 8-2-8-1-8-8, entitled “SNMP Agent Code Generation and SNMP Agent Framework for Network Management Application Development,” filed Jun. 15, 2004, commonly assigned to Lucent Technologies, Inc. and incorporated by reference herein.

### BACKGROUND OF THE INVENTION

The invention generally relates to a reusable asset center (RAC) framework in a development environment for network management applications and, more particularly, to a distribution adaptor (DA) within the RAC framework for providing the network management applications with distribution transparency.

While the invention is particularly directed to the art of network management application development, and will be thus described with specific reference thereto, it will be appreciated that the invention may have usefulness in other fields and applications.

By way of background, Guidelines for Definition of Managed Objects (GDMO) and Structure for Management Information (SMI) are existing standards for defining objects in a network. Managed objects that are defined can be accessed via a network management protocol, such as the existing Simple Network Management Protocol (SNMP). Various standards, recommendations, and guidelines associated with GDMO, SMI, and SNMP have been published. GDMO is specified in ISO/IEC Standard 10165/x.722. Version 1 of SMI (SMIv1) is specified in Network Working Group (NWG) Standard 16 and includes Request for Comments (RFCs) 1155 and 1212. Version 2 of SMI (SMIv2) is specified in NWG Standard 58 and includes RFCs 2578 through 2580. The latest version of SNMP (SNMPv3) is specified in NWG Standard 62 and includes RFCs 3411 through 3418.

ISO/IEC Standard 10165/x.722, GDMO, identifies: a) relationships between relevant open systems interconnection (OSI) management Recommendations/International Standards and the definition of managed object classes, and how those Recommendations/International Standards should be used by managed object class definitions; b) appropriate methods to be adopted for the definition of managed object classes and their attributes, notifications, actions and behavior, including: 1) a summary of aspects that shall be addressed in the definition; 2) the notational tools that are recommended to be used in the definition; 3) consistency guidelines that the definition may follow; c) relationship of managed object class definitions to management protocol, and what protocol-related definitions are required; and d) recommended documentation structure for managed object class definitions. X.722 is applicable to the development of any Recommendation/International Standard which defines a) management information which is to be transferred or manipulated by means of OSI management protocol and b) the managed objects to which that information relates.

RFC 1155, Structure and Identification of Management Information for TCP/IP-based Internets, describes the common structures and identification scheme for the definition of management information used in managing TCP/IP-based internets. Included are descriptions of an object information model for network management along with a set of generic types used to describe management information. Formal descriptions of the structure are given using Abstract Syntax Notation One (ASN.1).

RFC 1212, Concise Management Information Base (MIB) Definitions, describes a straight-forward approach toward producing concise, yet descriptive, MIB modules. It is intended that all future MIB modules be written in this format. The Internet-standard SMI employs a two-level approach towards object definition. An MIB definition consists of two parts: a textual part, in which objects are placed into groups, and an MIB module, in which objects are described solely in terms of the ASN.1 macro OBJECT-TYPE, which is defined by the SMI.

Management information is viewed as a collection of managed objects, residing in a virtual information store, termed the MIB. Collections of related objects are defined in MIB modules. These modules are written using an adapted subset of OSI's ASN.1. RFC 2578, SMI Version 2 (SMIv2), defines that adapted subset and assigns a set of associated administrative values.

The SMI defined in RFC 2578 is divided into three parts: module definitions, object definitions, and, notification definitions. Module definitions are used when describing information modules. An ASN.1 macro, MODULE-IDENTITY, is used to concisely convey the semantics of an information module. Object definitions are used when describing managed objects. An ASN.1 macro, OBJECT-TYPE, is used to concisely convey the syntax and semantics of a managed object. Notification definitions are used when describing unsolicited transmissions of management information. An ASN.1 macro, NOTIFICATION-TYPE, is used to concisely convey the syntax and semantics of a notification.

RFC 2579, Textual Conventions for SMIv2, defines an initial set of textual conventions available to all MIB modules. Management information is viewed as a collection of managed objects, residing in a virtual information store, termed the MIB. Collections of related objects are defined in MIB modules. These modules are written using an adapted subset of OSI's ASN.1, termed the SMI defined in RFC 2578. When designing an MIB module, it is often useful to define new types similar to those defined in the SMI. In comparison to a type defined in the SMI, each of these new types has a different name, a similar syntax, but a more precise semantics. These newly defined types are termed textual conventions, and are used for the convenience of humans reading the MIB module. Objects defined using a textual convention are always encoded by means of the rules that define their primitive type. However, textual conventions often have special semantics associated with them. As such, an ASN.1 macro, TEXTUAL-CONVENTION, is used to concisely convey the syntax and semantics of a textual convention.

RFC 2580, Conformance Statements for SMIv2, defines the notation used to define the acceptable lower-bounds of implementation, along with the actual level of implementation achieved, for management information associated with the managed objects.

Network elements need a way to define managed resources and access/manage those resources in a consistent and transparent way. GDMO does not provide a straight forward approach to defining resources. SMI does not provide for an object-oriented design of network management applications. Neither standard provides sufficient complexity of hierarchy or sufficient complexity of control for management of today's complex networks, particular today's telecommunication networks.

The present invention contemplates a DA within a RAC framework of a development environment for network management applications that resolves the above-referenced difficulties and others.

### SUMMARY OF THE INVENTION

A method of developing one or more application programs that cooperate to manage a distributed system comprising one or more servers is provided. At least one application program is associated with each server. In one aspect, the method includes: a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system, b) parsing the one or more resource definition language files to ensure conformity with the object-oriented resource definition language and creating an intermediate representation of the distributed system from the one or more conforming resource definition language files, c) processing the intermediate representation of the distributed system to form one or more programming language classes, one or more database definition files, and one or more script files, d) providing a reusable asset center framework to facilitate development of the one or more application programs, the reusable asset center including a distribution adaptor framework that provides each application program with distribution transparency for remote and local operations associated with the one or more servers, and e) building the one or more application programs from at least the one or more programming language classes, one or more database definition files, one or more script files, and the reusable asset framework.

A method of developing one or more application programs in operative communication to manage a network including one or more servers is provided. At least one application program is associated with each server. The method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network created in the parsing step includes a parse tree, c) processing the parse tree to form one or more programming language classes, wherein the one or more programming language classes formed include at least one of one or more system classes, one or more module classes, one or more managed object classes, and one or more composite attribute classes, d) providing a reusable asset center framework to facilitate development of the one or more application programs, the reusable asset center including a distribution adaptor framework that provides each application program with distribution transparency for remote and local communications for the server with which the application program is associated, and e) building the one or more application programs from at least the one or more programming language classes and the reusable asset framework.

A method of developing an application program to manage a network is provided. In one aspect, the method includes: a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network, b) parsing the one or more resource definition language files to ensure conformity with the object-oriented resource definition language and creating an intermediate representation of the network from the one or more conforming resource definition language files, wherein the intermediate representation of the network includes object meta-data, c) processing the object meta-data to form one or more programming language classes, one or more database definition files, and one or more script files, wherein the one or more programming language classes formed include at least one of an index class and a query class, d) providing a reusable asset center framework to facilitate development of the application program, the reusable asset center including a distribution adaptor framework that provides the application program with distribution transparency for remote and local operations, and e) building the application program from at least the one or more programming language classes, one or more database definition files, one or more script files, and the reusable asset framework.

Benefits and advantages of the invention will become apparent to those of ordinary skill in the art upon reading and understanding the description of the invention provided herein.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an embodiment of a reusable asset center (RAC) development environment for development of network management applications.

FIG. 2 is a block diagram of an embodiment of a run-time network management environment with network management applications developed by the RAC development environment.

FIG. 3 is a block diagram of an embodiment of a resource definition language file(s) block of the RAC development environment.

FIG. 4 is a block diagram of an embodiment of a parser(s) block of the RAC development environment.

FIG. 5 is a block diagram of an embodiment of an options block of the RAC development environment.

FIG. 6 is a block diagram of an embodiment of a code generator(s) block of the RAC development environment.

FIG. 7 is a block diagram of an embodiment of a RAC management framework block of the RAC development environment.

FIG. 8 is a block diagram of an embodiment of a run-time tool(s) block of the RAC development environment.

FIG. 9 is a block diagram of an embodiment of a RAC development environment for generating distribution adaptor (DA) code.

FIG. 10 is a call flow diagram of DA communication architecture within a standard layered communication architecture.

FIG. 11 is a block diagram of an embodiment of classes of DA code generated by the RAC development environment.

### DETAILED DESCRIPTION OF THE PREFERRED EMBODIMENTS

Referring now to the drawings wherein the showings are for purposes of illustrating the preferred embodiments of the invention only and not for purposes of limiting same.

In general, a reusable asset center (RAC) development environment for network management application development is provided. RAC, as used herein, generically refers to a reusable set of frameworks for network management application development. The set of frameworks is referred to as the RAC management framework. Network, as used herein, generically refers to a system having a set of resources arranged in a distributed architecture. For example, the RAC development environment may be used to develop network management applications for a TCP/IP-based network or any other type of communication network. For example, the RAC development environment may be used to develop network management applications for landline and/or wireless telecommunication networks. Likewise, the RAC development environment may be used to develop management applications for any type of system having a distributed architecture. Defined as such, the RAC framework is inherently reusable in other networks (i.e., systems). Moreover, major portions of code used to build management applications in the RAC development environment are inherently reusable.

The RAC development environment includes a Managed Object Definition Language (MODL) to specify managed objects in a network or system design and management information associated with the managed objects. The syntax for MODL is object-oriented and the semantics are similar to GDMO. This provides a simplified language for defining data models and acts as a single point translation mechanism to support interacting with different schema types. In essence, MODL provides a protocol-independent mechanism for accessing management information for managed objects within the network design. MODL can be used to define data models describing the managed resources of the network design in terms of managed resources having managed objects, define data types (attributes) representing various resources and objects, and define relationships among the managed resources and objects.

MODL allows network management applications to specify the resources to be managed in a given network design. The RAC development environment also includes MODL code generation from MODL files defining the managed objects and information. This provides automatically generated code to access these resources. Network management application developers can choose to make these resources persistent or transient. Developers can choose among various options to customize the code generation to suit the needs of the operators/maintainers (i.e., providers) of the network. MODL is object-oriented and allows applications to capture complex resources in a systematic way.

The RAC management framework provides an operation, administration, and maintenance (OAM) management framework catering to common OAM needs of the network and its managed resources and objects. The services offered by the RAC management framework range from standard system management functions to generic functions, such as event management, SNMP proxy interface, persistency services, and view management. These services are offered in a protocol-independent and operating system-independent manner.

Most of the common OAM needs of network elements are described in the ITU-T specifications X-730 through X-739 and are known as system management functions. The process leading to development of a RAC management framework provides for systematic and consistent reuse of code. In addition to requirements prescribed by applicable standards, the RAC management framework also provides, for example, functionalities such as persistence, view management and SNMP interface capabilities.

The following requirements of ITU-T X.730 (ISO/IEC 10164-1: 1993(E)) associated with Object Management Function (OMF) services are fully supported in the RAC management framework: 1). creation and deletion of managed objects; 2) performing actions upon managed objects; 3) attribute changing; 4) attribute reading; and 5) event reporting. The RAC management framework also provides, for example, ITU-T X.731-like state management functionality through effective use of callbacks and event reporting.

The RAC management framework provides, for example, a minimal subset of attributes for representing relations as described in ITU-T X.732 (ISO/IEC 10164-3). Certain attributes in the RAC management framework provide, for example, ways to define and create parent and child relationships between managed resources. This enables developers to specify hierarchical structures in the data model representing the network design.

The RAC management framework includes a standalone event management framework to implement event-handling services as described by ITU-T X.734 (ISO/IEC 10164-5). Regarding event-handling services, the RAC management framework, for example, permits: 1) definition of a flexible event report control service that allows systems to select which event reports are to be sent to a particular managing system, 2) specification of destinations (e.g. the identities of managing systems) to which event reports are to be sent, and 3) specification of a mechanism to control the forwarding of event reports, for example, by suspending and resuming the forwarding.

In addition to standard services, the RAC management framework provides additional capabilities associated with the functionality of various potential network elements. The RAC management framework also provides facilities to maintain data integrity in terms of default values and range checks and persistency of managed resources. For example, managed objects can be made persistent and all the OMF services are supported on these persistent managed objects. The managed objects can be manipulated from the back-end using standard Java database connectivity (JDBC) interfaces and synchronization is maintained so as to retain data integrity. This enables developers to manipulate data from multiple interfaces.

The RAC management framework provides a concept of views and view management services. Many network management applications, especially client applications, do not want to access or store the information about all the objects in the data model. The concept of views in the RAC management framework allows developers to create network management applications with access to a subset of the data model. Network management application developers can specify a view using a View Definition Language (VDL) that is included in the RAC development environment. View management services can be used to manage a cross-section of managed objects and associated resources in a single unit called a View. Most of the OMF services are also provided through the views.

The RAC management framework allows transparent distribution of the network management application. This decouples the network management application from changes in platforms and middleware environments. The network management application can be deployed in agent clients and agent servers servicing operation and maintenance centers (OMCs) (i.e., managers). The interface to the OMC can be Common Object Request Broker Architecture (CORBA), SNMP, JDBC, or another standard communication protocol for network management. For example, by simple inheritance, the agent server interface to the OMC can be extended to support other network management protocols, such as common management information protocol (CMIP), extensible markup language (XML), etc.

One of the key advantages for developers is that the RAC development environment automates development of portions of code with respect to the overall network management application. The RAC development environment generates the code based on the data model defined in MODL. The objects in the model get translated into subclasses in MODL code and access to the objects is generated using a build process in the RAC development environment. If the data model changes, corresponding MODL files can be revised and corresponding MODL code can be re-generated. Thus, streamlining change management of the network management application. The revised network management application is provided in a consistent and controlled manner through the object-oriented programming characteristics of MODL and the RAC management framework.

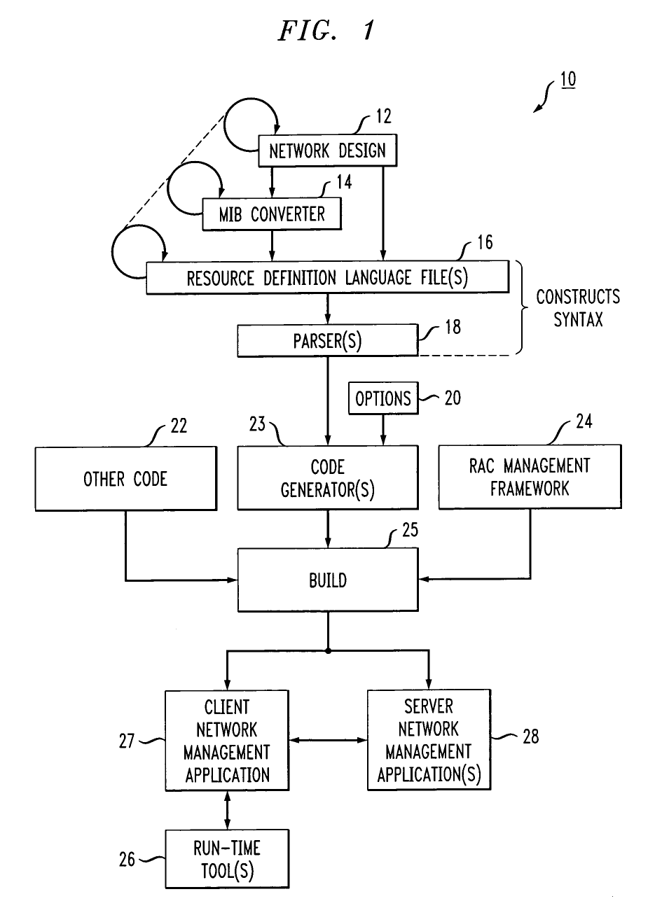

With reference to FIG. 1, a RAC development environment 10 includes a network design 12, an MIB converter 14, a resource definition language file(s) block 16, a parser(s) block 18, an options block 20, an other code block 22, a code generator(s) block 23, a RAC management framework block 24, a build process 25, a run-time tool(s) block 26, a client network management application 27, and a server network management application(s) 28. The RAC development environment 10 also includes computer hardware for storing and/or operating the various software development processes shown in FIG. 1. The computer hardware used in conjunction with the RAC development environment 10 may range from a network with multiple platforms to a stand-alone computer platform. The various processes for software development described herein may operate on any suitable arrangement of various types of computer equipment with various types of operating systems and various types of communication protocols. Thus, it is to be understood that the software development processes described herein do not require any specialized or unique computer architecture for the RAC development environment 10. The RAC development environment 10 represents an exemplary development cycle used by developers when preparing network management applications. Typically, developers begin with a design or data model for a network or system. This is depicted by the network design 12 and may include any design documentation describing the network and its resources or elements that is useful to the developers (i.e., data model). The network design 12 may include an existing MIB for one or more network resources.

If the network design 12 includes one or more MIBs, the MIB converter 14 converts the information in the MIBs to resource definition language file(s) 16. The developers use the network design 12 as source data for representing the remaining network resources and objects to be managed in the resource definition language file(s) block 16. The developers may also use the network design 12 to integrate the file(s) created by the MIB converter 14 with the other file(s) in the resource definition language file(s) block 18. Thus, the resource definition language file(s) block 16 includes one or more files defining the resources and objects within constructs and in appropriate syntax for one or more resource definition languages associated with the RAC development environment 10. Additional files may be included in the resource definition language file(s) block 18 defining one or more views of the resources and/or objects.

Files from the resource definition language file(s) block 18 are provided to an appropriate parser in the parser(s) block 18 to check for construct and syntax compliance and to build a parse tree. The parse tree is provided to the code generator(s) block 23. The options block 20 specifies certain options related to code generation by the code generator(s) block 23. The code generation options are customized by the developers based on the network design, parse tree, developer preferences, and/or network management application customer/user preferences.

The code generator(s) block 23 generates code for each managed resource and object defined in the resource definition language file(s) 16. The generated code provides various hooks and callbacks, which can be used by the developers to customize the flow of operations and behavior of the network management applications. The generated code primarily includes extensions of RAC management framework classes and eases the burden of coding and maintaining repeated functionality. The RAC management framework block 24 includes code organized in a group of subordinate frameworks. The RAC management framework 24 is implemented as a set of interrelated patterns (i.e., frameworks) that provide common functionality which can be selectively associated with the managed resources/objects and included in the generated code. The other code block 22 includes, for example, user-specific code and main methods which perform the initialization to get the final network management application.

The generated code from the code generator(s) block 23 is compiled and linked with code from the other code block 22 and the RAC management framework block 24 in the build process 25 to create a client network management application 27 and one or more server network management applications 28. At any stage in the application development, developers can add, delete or modify the managed resources/objects in the resource definition language files, re-generate the resource definition language code with new and/or revised managed resources/objects, and re-build the network management applications.

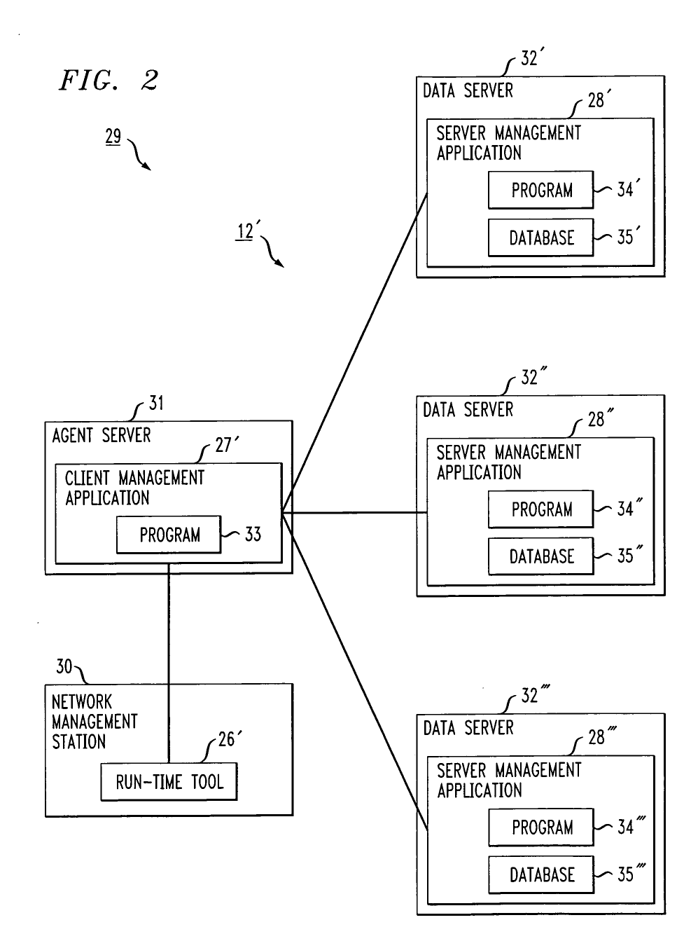

With reference to FIG. 2, an embodiment of a run-time network management environment 29 includes a network design 12′ to be managed in communication with a network management station 30. The network design includes an agent server 31 in communication with a first data server 32′, a second data server 32″, and a third data server 32′″. The network management station 30 includes an embodiment of the run-time tool 26′. The agent server 31 includes an embodiment of the client network management application 27′. The data servers 32′, 32″, 32′″ each include a corresponding embodiment of the server network management application 28′, 28″, 28″′. The client network management application 27′ includes an application program 33. Each server network management application 28′, 28″, 28′″ includes a corresponding application program 34′, 34″, 34′″ and management database 35′, 35″, 35′″.

Each of the data servers 32′, 32″, 32′″ includes one or more objects to be managed. For example, if any two network resources 32 are the same and the objects to be managed for both resources are also the same, the corresponding server network management application 28 may be the same on both resources. Otherwise, the application programs 34 and management databases 35 in the client network management applications are different based on the type of resource and/or type of objects to be managed.

The run-time tool 26′ controls and monitors the data servers 32′, 32″, 32′″ through communications with the client network management application 27′. The client network management application 27′ passes communications from the run-time tool 26′ to the appropriate server network management application 34. The client network management application 27′ also passes communications from the server network management applications 34′, 34″, 34′″ to the run-time tool 26′.

With reference to FIG. 3, an embodiment of the resource definition language file(s) block 16 includes managed object definition language (MODL) file(s) 36, view definition language (VDL) file(s) 38, and network management forum (NMF) file(s) 39. The VDL file(s) 38 are optional. MODL is a language used to organize the managed resources. MODL allows for definition of managed resources as managed object classes. The MODL file(s) 36 include constructs to organize the data model of the network design into managed object classes. This facilitates readability and provides a mechanism for abstracting the managed resources in the network design. VDL is a specification language based on MODL that describes managed object views. Each VDL file 38 (i.e., managed object view) is a collection of managed attributes that are scattered across various managed objects. The VDL file(s) 38 are entities that are essentially wrappers for corresponding managed objects included in the respective managed object views. The NMF file(s) 39 acts as an input for generating the classes required to access the managed objects and their attributes. The NMF file(s) 39 supply mapping information between MIB tables and managed object classes.

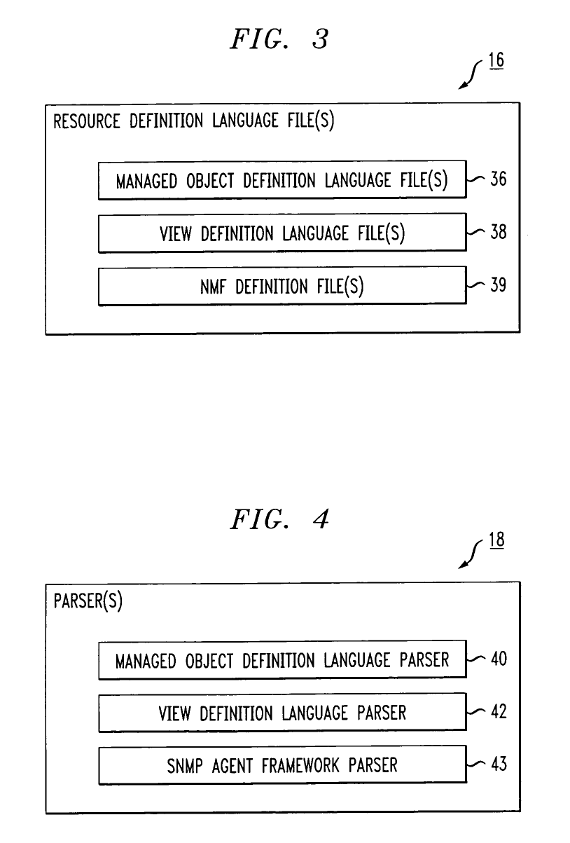

With reference to FIG. 4, an embodiment of the parser(s) block 18 includes an MODL parser 40, a VDL parser 42, and an SNMP agent framework (SAF) parser 43. The VDL parser 42 is optional. The MODL parser 40 receives the MODL file(s) 36 and builds an intermediate representation of the file contents that includes a parse tree and object meta-data. The parse tree and object meta-data is provided to the code generator(s) 23 for generation of MODL and database management code. The object meta-data is also provided to the VDL parser 42. The VDL parser 42 receives the VDL file(s) 38 and the object meta-data and builds view meta-data. The object meta-data and view meta-data are provided to the code generator(s) 23 for generation of VDL code. The SAF parser 43 receives MODL files created by the MIB converter and the NMF files and creates an output that is provided to the code generator(s) 23 for generation of SAF code.

With reference to FIG. 5, an embodiment of the options block 20 includes command line options 44 and an options file 46. The options file 46 is optional. The command line options 44 include arguments and parameters to commands to initiate code generation. Various combinations of arguments and parameters are optional and permit developers to customize code generation to the current stage of application development and their current needs. The options file 46 is a sequence of commands in a file that similarly permit developers to customize code generation. The options file 46, for example, can specify reuse of code that was generated previously so that current code generation may be limited to areas that have changed.

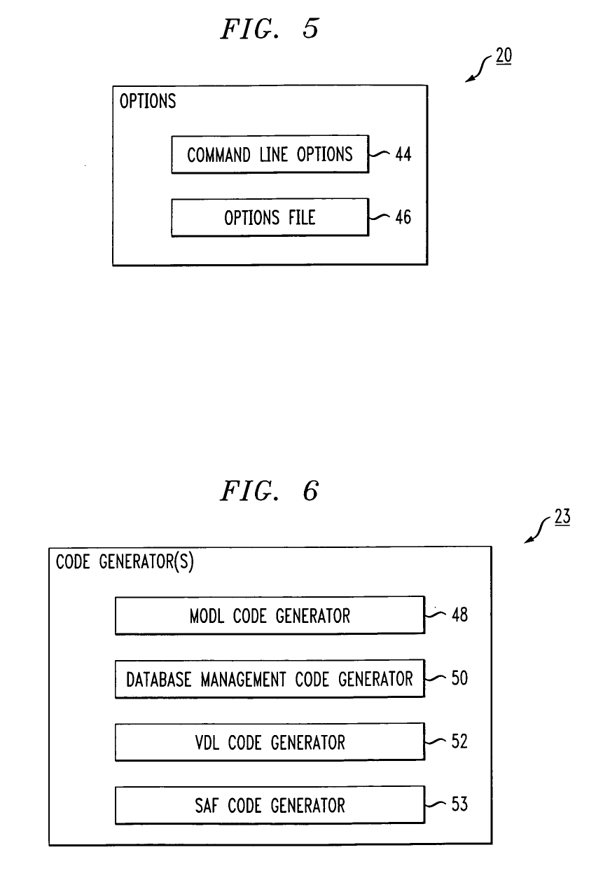

With reference to FIG. 6, an embodiment of the code generator(s) block 23 includes an MODL code generator 48, a database management code generator 50, a VDL code generator 52, and an SAF code generator 53. The MODL code generator 48 receives the parse tree from the MODL parser 40 and instructions from the option(s) block 20 for generation of MODL code. The MODL code generator 48 generates code for instantiating and accessing the managed resources and objects in the network design from the MODL file(s) 36. The database management code generator 50 receives object meta-data from the MODL parser 40 and instructions from the option(s) block 20 for generation of database management code. The database management code generator 50 generates database schema for transient and/or persistent managed objects and trigger definitions for database updates from the MODL file(s) 36. The VDL code generator 52 receives view meta-data from the VDL parser 42 and instructions from the option(s) block 20 for generation of VDL code. The VDL code generator 52 generates code for defining managed object views from the MODL file(s) 36 and VDL file(s) 38. The SAF code generator 53 generates code for providing an SNMP interface to managed object resources.

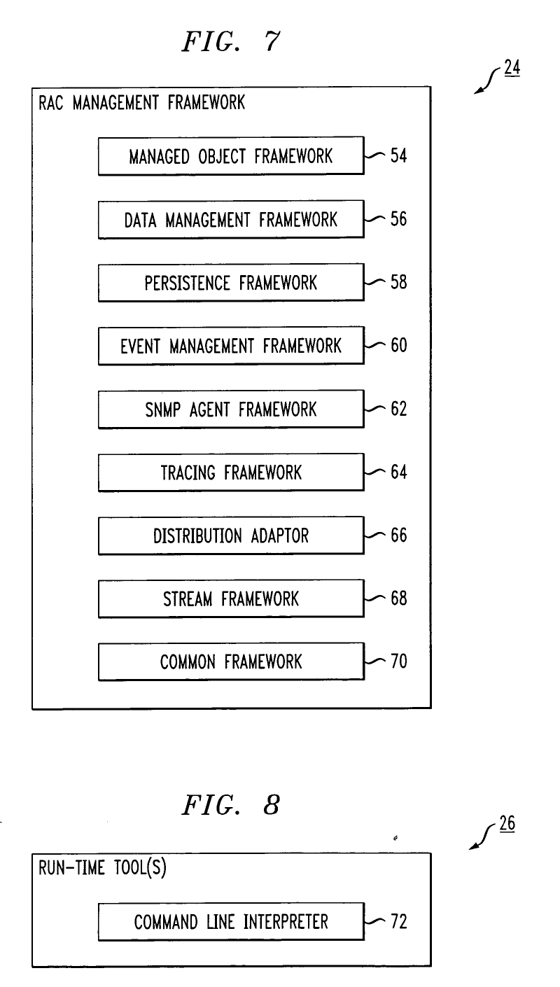

With reference to FIG. 7, an embodiment of the RAC management framework block 24 includes a managed object framework (MOF) 54, a data management framework (DMF) 56, a persistence framework (PF) 58, an event management framework (EMF) 60, an SNMP agent framework (SAF) 62, a tracing framework 64, a distribution adaptor (DA) 66, a stream framework 68, and a common framework 70. MOF 54 includes a set of classes that work in close cooperation to provide the management functionality of the network management applications. The MOF 54 is the core framework and provides object representations and interfaces for network management applications.

DMF 56 is used to make certain managed objects persistent and makes these persistent managed objects accessible to network management stations (NMSs). The DMF 56 also maintains consistency of the persistent data and permits various servers within the network design to share the data, for example, in real-time. PF 58 provides a portable persistent database interface to network management applications. This permits MODL and other coding for the applications to be developed transparent of any underlying database implementation.

EMF 60 includes a centralized event management server that performs event management routing and broadcasting. The EMF 60 unifies various system event generations and handling schemes into one uniform event processing model. SAF 62 provides network management applications with a gateway between MOF and SNMP protocols. SAF 62 acts as a proxy for SNMP protocol. SAF 62 also provides an interface definition language (IDL) interface through which other system elements can communicate using CORBA.

The tracing framework 64 provides network management applications with an option to emit tracing information that can be saved to a log file for subsequent problem analysis. The tracing framework 64 provides developers and users with multiple tracing levels. DA 66 is an adaptation layer framework for transparent distributed programming. DA 66 provides a pattern for utilizing client and server object proxies to allow code for distributed applications to be written without having to explicitly deal with distribution issues.

The stream framework 68 supports the encoding of objects into a stream and the complementary reconstruction of objects from the stream. The stream framework 68 permits objects to be passed by value from the client to the server through various communication mechanisms. The common framework 70 includes a set of utility classes that are used across the RAC management framework 24. The common framework 70 reduces redundancy across the RAC management framework 24, thereby reducing code for network management applications.

With reference to FIG. 8, an embodiment of the run-time tool(s) block 26 includes a command line interpreter 72. The command line interpreter 72 is a utility for monitoring and controlling managed objects associated with a network management application. The command line interpreter 72 includes interactive and batch modes of operation.

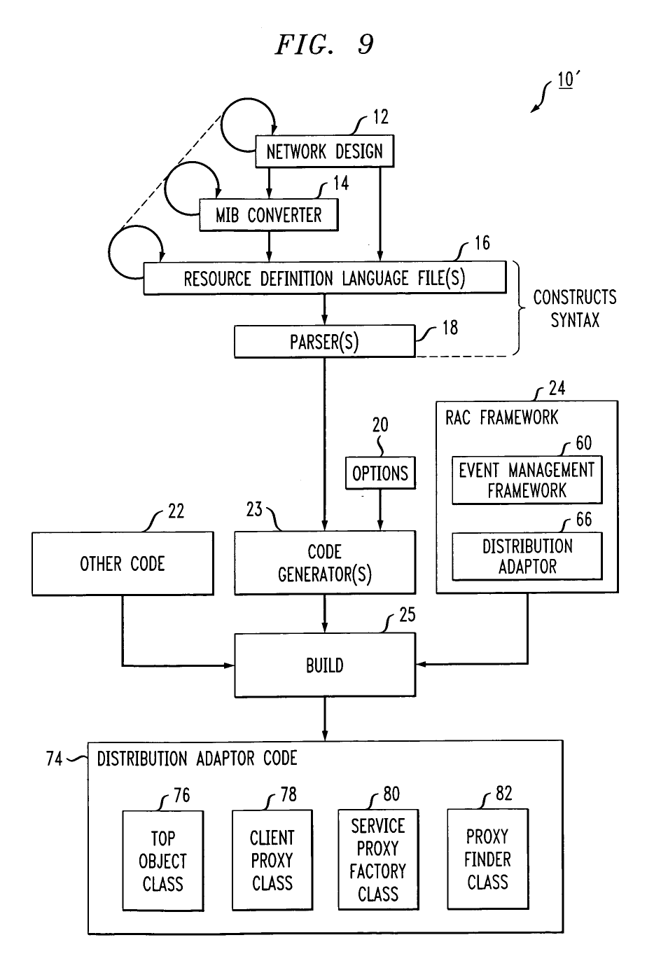

With reference to FIG. 9, an embodiment of a RAC development environment 10′ for generating DA code includes the network design 12, MIB converter 14, resource definition language file(s) block 16, parser(s) block 18, options block 20, other code block 22, code generator(s) block 23, RAC framework block 24, build process 25, and DA code 74. The network design 12, MIB converter 14, resource definition language file(s) block 16, parser(s) block 18, options block 20, other code block 22, code generator(s) block 23, RAC framework block 24, and build process 25 operate as described above with reference to FIGS. 1 and 3-7. The build process 25 includes the generation of the DA code 74. The EMF 60 and DA 66 of the RAC framework block 24 are shown for their particular relevance to the generation of DA code 74. The DA code 74 includes a top object class 76, a client proxy class 78, a service proxy factory class 80, and a proxy finder class 82.

In addition to the DA features described above with reference to FIG. 7, the DA 66 can be extended to address many issues that are associated with real-time distributed object-oriented systems (e.g. performance, security, etc.). Network management application programs that are written using DA 66 are less tangled. Therefore, the programs are simpler and more reusable. Accordingly, at least one motivation for using DA 66 comes from the observation of the code-tangling phenomenon. The abstraction and composition mechanisms at the heart of object-oriented programming (OOP) do a great job of capturing the functionality of the applications, but they do not provide a “natural fit” for supporting the distribution constraints, real-time constraints, and communication strategies.

DA code 74 provides distribution transparency to network management application programs. A client network management application desires transparency between local and remote operations because it does not want to explicitly identify the location or implementation that will service its request. It is especially important in a distributed heterogeneous environment. With DA 66, the end result is the generation of DA code 74 that preserves the “original design component object model” in the network management application.

The client proxy class 76 provides distribution abstraction to the client network management application 27. The top object class is the base class of DA and EMF. All EMF and DA classes are inherited either directly or indirectly from the top object class using a single inheritance tree. The service proxy factory class 80 is used to specify the configuration of component distribution. For every instance of client and server interaction using RAC IDLs or equivalent, the network management application needs to instantiate the service proxy factory class 80. The proxy finder class 82 is a find proxy instance from factory collections.

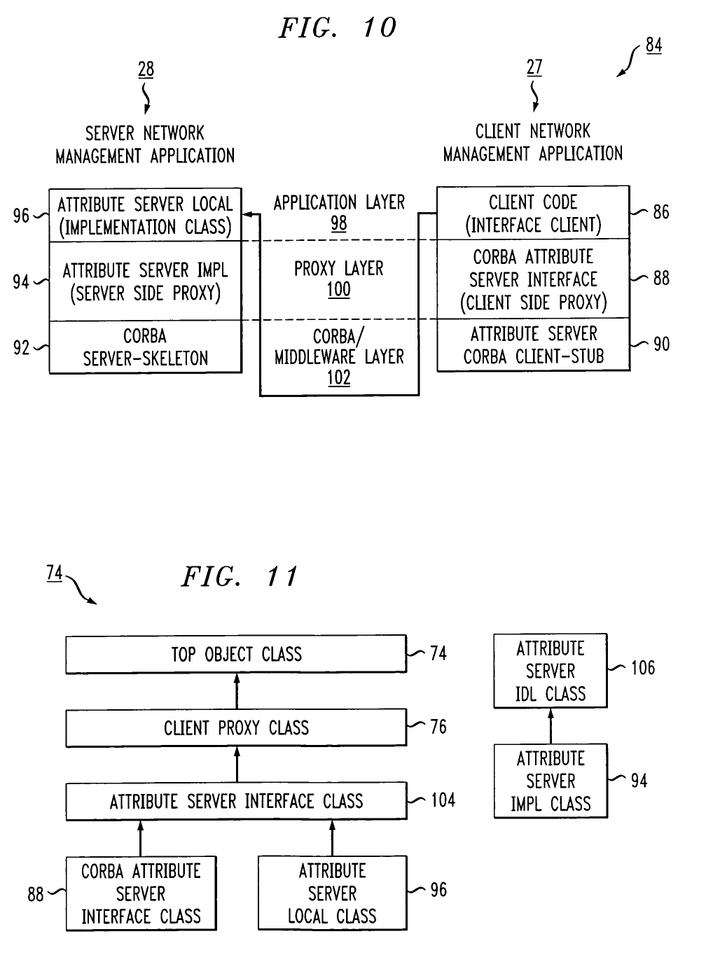

With reference to FIG. 10, a call flow 84 shows how the client network management application 27 communicates with the server network management application 28 from an interface client 86 through a client side proxy 88, an attribute server CORBA client-stub 90, a CORBA server-skeleton 92, and a server side proxy 94, to an implementation class 96. The diagram relates these components to standard communication layers—application layer 98, proxy layer 100, and CORBA/middleware layer 102. As shown, the interface client 86 and the implementation class 96 are within the application layer of the client and server network management applications 27, 28, respectively. The client side proxy 88 and the server side proxy 94 are within the proxy layer 100 of their respective network management applications. The CORBA/middleware layer 102 is where the attribute server CORBA client-stub 90 and CORBA server-skeleton 92 serve the client and server network management applications 27, 28, respectively.

The client side proxy 88 resides in the client network management application 27 and may expose the same application program interface (API) as the server network management application 28 or it can have a different set of APIs that are tailored to desired performance or ease of use. The server side proxy 94 resides in the server network management application 28 and relays messages from client side proxy 100 to the implementation class 92 in the server network management application 28. The server side proxy 94 is used to hide functionality that does not belong to the server network management application 28. The call flow 84 is an example of how DA can be used to provide location transparency. For example, if there are three remote servers of the same type running under different platforms, by using DA proxies, the remote client can access each of the three servers polymorphically.

With reference to FIG. 11, a block diagram of DA code 74 includes the top object class 74, client proxy class 76, CORBA attribute server interface class 88, attribute server IMPL class 94, attribute server local class 96, an attribute server interface class 104, and an attribute server IDL class 106. The diagram represents the hierarchy of the classes. As shown, the CORBA attribute server interface class 88 and attribute server local class 96 are sub-classes of the attribute server interface class 104. The attribute server interface class 104 is a sub-class of the client proxy class 76 which is a sub-class of the top object class 74. Additionally, the attribute server IMPL class 94 is a sub-class of the attribute server IDL class 106.

An example of DA programming using CORBA/middleware for transport is provided below. Various classes described above are defined in the example.

First, the abstract C++ interface class, i.e., attribute server interface 104 is defined as follows:

class class AttributeServerInterface : public ClientProxy
{
//define methods for the interface
}

Then, an implementation class for the attribute server interface class 104, i.e., attribute server local class 96 is defined as follows:

class AttributeServerLocal : public
AttributeServerInterface
{
//implement the methods for the interface
}

The protocol for transporting over the middleware is defined below. In the case of CORBA, an IDL interface to the attribute server is defined, i.e., attribute server IDL class 106.

```
interface AttributeServer
{
    //define IDL methods here
    //Note: there does not need to be a 1 to 1 mapping
of IDL methods to C++ interface methods.
    //Just make sure that the IDL methods are sufficient
to transport all the calls for the C++ interface.
}
```

Next, the CORBA implementation class, i.e., attributes server IMPL class 94, (sometime called the servant class or the TIE class), is defined as follows:

class AttributeServerImpl
#ifdef RUBY_USES_POA_SERVANT
: public virtual POA_AttributeServer
#endif
{
//need to implement the IDL interface such that it
will convert the IDL call into the C++ interface call and
forward the C++ call to the C++ interface Object
}

The C++ interface proxy, i.e., CORBA attribute server interface class 88, is defined as follows:

```
class CorbaAttributeServerInterface : public
AttributeServerInterface
{
    implement the ClientProxy::bind( ) method
    This method is called at object creation and can be
used to retrieve the CORBA ObjectReference
    Unless your ObjectReference cannot change it is
typically a good idea to call bind( ) in the beginning of
each method call, to ensure your ObjectRefence is not
stale
    implement all the methods of the C++ interface such
that each C++ call is mapped to the corresponding IDL
call
}
```

The client network management application registers the C++ interface proxy with the proxy finder class 82 (FIG. 9). This is accomplished by creating an instance of the service proxy factory class 80 (FIG. 9) as follows:
ServiceProxyFactory<CorbaAttributeServerInterface, AttributeServerInterface>serverInterface1(serviceName, serverReference, serverInstanceName, serverInstanceId);

The client network management application 27 (FIG. 1) can retrieve a reference to the C++ interface proxy by calling the proxy finder class 82 (FIG. 9) as follows:
ProxyFinder<AttributeServerInterface>::GetProxy(serviceName, serverInstanceName, serverInstanceId);

With the classes defined, a real world example may include two processes that are both instances of the MyServer class. The developers want both processes to communicate with each other using CORBA, but would like local calls to be normal function calls. The exemplary DA code 74 below provides the desired communications for the MyServer class.

```
class MyServer
{
    initialize (int instanceId)
{
    //Set your processes ServerId
    ServerId* serverId = new
ServerId(“MyServer”,instaceId);
    ServerId::thisServerId(*serverId);
    //Have 2 options for local communication
    //Can have local calls made via CORBA
    //Or make them local function calls
    //Here will make local calls be function calls
    //if desired to use CORBA for all calls then
remove the “if” and only use
CorbaAttributeServerLocal for the proxy
registrations
    int maxNumOfServers = 2;
    for(int idx = 1; idx <= maxNumOfServer;idx++)
    {
        //make calls to the local process function
    calls
        if( instanceId == idx)
        {
            ServiceProxyFactory<AttributeServerLocal,
                AttributeServerInterface >*
            Server1 =
                new  ServiceProxyFactory<
            AttributeServerLocal,
                AttributeServerInterface >
                (“MyServer”, (void*) “MyServer”,
            “MyServer”, idx);
            } else { //make remote calls use
            CORBA
                ServiceProxyFactory<
            CorbaAttributeServerInterface,
                    AttributeServerInterface >*
                Server1 =
                    ServiceProxyFactory<
                AttributeServerLocal,
                    AttributeServerInterface >
                    ( “MyServer”,
                (void*)“MyServer”,
                “MyServer”,idx);
            }
    }
    //get a refernce to our local interface object
    AttributeServerInterface* lasi =
        ProxyFinder<AttributeServerInterface>::Get
    Proxy(
            “MyServer”, “MyServer”, instanceId );
    //Initialize our CORBA Objects
    POA_AttributeServer_tie<AttributeServerImpl>*
    server =
        RUBY_CORBA_NEW
    POA_AttributeServer_tie<AttributeServerImpl>
            (new AttributeServerImpl(lasi));
    //register your tie object with your POA
    //do any other initialization steps
}
void run( )
{
        orb->run( )
        // and the orb will send all CORBA request to
    your AttributeServerImpl object which will convert
    them to requests to your AttributeServerLocal object
    }
    someOtherMethod( )
    {
        //need to talk to both Server.1 and Server.2
        AttributeServerInterface* asi1 =
            ProxyFinder<AttributeServerInterface>::Get
        Proxy(
                “MyServer”, “MyServer”, 1 );
        AttributeServerInterface* asi2 =
            ProxyFinder<AttributeServerInterface>::Get
        Proxy(
                “MyServer”, “MyServer”, 2 );
        //will be a CORBA call if this server is not
        Server.2
        asi1->getAttributes(...);
        //will be a CORBA call if this server is not
        Server.2
        asi2->getAttributes(...);
    }
}
```

Note that once the proxies are configured, as above, the client network management application uses the interface the same regardless if it is a local call or a remote call.

As described above, the common framework 70 (FIG. 7) includes a set of utility classes that are used across the other RAC frameworks for various purposes. The common framework provides miscellaneous functionality to the other RAC frameworks and reduces redundancy across the RAC frameworks and network management application code.

The common framework 70 (FIG. 7) includes an IorReceiver class, an IorSender class, a RacError class, a RacException class, a RacErrorCodes class, a RubyError class, a ServerID class, a RubyCorbaHelper class, a RubyDelay class, and a RacMessageQueue class.

The IorReceiver class is used to receive stringified object reference from the server that supplies its CORBA object reference. This class uses the UDP protocol to communicate with a specified host and a specified port number to get stringified IOR (interoperable object reference) of some remote CORBA server. Once the IorReceiver class receives stringified IOR, it extracts the CORBA IOR from that string. The default value for a host name is “127.0.0.1.” This is the local host. The default value for a port number is 10000. The default value for a timeout is five (5) seconds. The default value for a retry count is five (5).

The IorSender class is used by any CORBA server to supply their IOR to their CORBA based clients. This class will spawn a separate thread that waits on the UDP port specified by the user/application. Once any client requests IOR on that UDP port, this class sends the stringified IOR of the server back to the client. The client, on receiving this stringified IOR, unstringifies the IOR and gets the object reference of the server. A multi thread version may be implemented. However, a single thread environment using, for example, the ACE Reactor may also be implemented.

The RacError class is used as an abstraction of all errors in the RAC framework. The RacException class is a sub-class of std::Exception and is used to throw exceptions in the RAC frameworks. User's can extract RacError from the RacException class. The RacErrorCodes class provides a list of globally defined error codes. Users are advised to use these definitions while checking the return values of RAC framework methods.

The RubyError class is used to propagate errors from the callee to the caller. This is an alternate to the native C++ exception handling. The RubyError class contains the error code and some additional descriptions associated with the error code. This class will be used in RAC frameworks to propagate the errors between caller and callee, including distributed calls using CORBA. The RubyError class maintains the error codes and descriptions on a per-thread basis. Hence, it is multi-thread safe.

The ServerId class is used to encapsulate the server instance. It has a name and an integer to uniquely identify different servers. The RubyCorbaHelper class is used to initialize a CORBA environment. The RubyDelay class is used to set a delay for any Ruby method that needs to set a wait delay. The delay can be executed with specified seconds and nano seconds up to a specified maximum retry count. The RacMessageQueue class is a wrapper class of ACE_Message_Queue. It provides the option of flexible queue size to users. The RacMessgeQueue defines a special kind of ACE_Message_Queue so that the low_water_mark and high_water_mark are always the same. Additionally, the water_mark can be reset if the queue is full.

Some exemplary code involving classes in the common framework are provided below. The following exemplary code initializes and provides a reference to the Object Request broker:

CORBA::ORB* orb = RubyCorbaHelper::initOrb(argc, argv);

The following exemplary code identifies the current server and registers the server:

ServerId serverNameId;
serverNameId.classId = “DataServer”;
serverNameId.instanceId = 0;
ServerId::thisServerId( serverNameId );
attrServerCorbaRef =
RubyPoaSpecific::registerObjRefWithPoa(
server, serverNameId, “AttributeServer” );

The following exemplary code creates and publishes Ior:

IorSender::setIorPort( iorPort );
RubyCorbaHelper::publishIorAndImplIsReady( “DataServer”,
attrServerCorbaRef);

The DA 66 (FIG. 9) provides object oriented interfaces that can be used in conjunction with an available transport media regardless of the location of the actual object. For example, RAC framework interfaces may be implemented for transported via CORBA or TCP/IP. Other transport medias and protocols may also be implemented.

More specifically, the DA provides a pattern for implementing an interface. For a given interface, there are at least two proxies and one concrete implementation class. The two proxies are mated pairs and are typically referred to as the client side proxy 88 (FIG. 10) and the server side proxy 94 (FIG. 10). The client side proxy is responsible for sending a client request over a transport and the server-side proxy is responsible for receiving the request from a transport and dispatching it to the concrete implementation object. Using this approach, the DA shields the user of the interface from the communication and therefore can switch communication protocols without affecting the user. However, the DA does not shield the entire application from the communication mechanism. For example, the network management application is responsible for configuring and registering the communication medium.

The DA provides several CORBA interfaces to support the C++ interfaces between code generated for a network management application using the RAC development environment 10′ (FIG. 9). Although these C++ interfaces are used within the network management application, it is import for the network management application to know what interfaces are being used and how to configure them. The following table shows exemplary CORBA interfaces and the C++ interfaces that use the CORBA interface as well as the corresponding client proxy and server proxy.

| CORBA | | | |
|---|---|---|---|
| interface | C++ interface | Client Proxy | Server Proxy |
| Attribute | Attribute Server | Corba Attribute | Attribute |
| Server | Interface | Server Interface | Server Impl |
| Mof Notifier | Mof Notifier | Corba Mof Notifier | Mof Notifier |
| | Interface | Interface | Impl |
| View Server | Mo View Server | Mo View Server | Mo View |
| | Interface | Corba | Server Impl |
| Event Srvr | Event Srvr | Event Srvr | Event Srvr_i |
| MAP | Abstract | CORBA | |
| Event Handler | V Event Abstract | V Event CORBA | Event Handler |
| Proxy MAP | | | Proxy |
| Name Server | Name Server | Corba Name | Name Server |
| | Interface | Server Interface | Impl |
| Log File | None | None | None |

The code for a network management application includes server map classes that are singleton classes providing, for example, the CORBA object references for various IDL interfaces between components of the RAC framework. Since the RAC framework does not understand the distribution details of the network management application or how the network management application manages the CORBA object references, it is the responsibility of the network management application to implement the server map classes. These server map classes may only be needed if the network management application uses CORBA to communicate amongst its servers and if the corresponding servers are also using the CORBA interface.

The following table lists the various server map classes along with the CORBA interfaces with which they are associated:

| | |
|---|---|
| Server Map Class | CORBA Interface/Related RAC Framework |
| ServerMap | AttributeServer, MofNotifier, NameServer/MOF |
| EventServerMap | EventSrvrMAP, EventHandlerProxyMAP/EMF |
| LogServerMap | LogFile/Tracing Framework |
| ViewServerMap | ViewServer/DMF |

A server map class should be implemented with an understanding of how the object references are managed to avoid creating concurrency issues and to be as efficient as possible. For example, the network management application may use AMW/HARP to manage the object references. In this example, the ServerMap serves as a bridge between the network management application and HARP.

Exemplary code for implementing the server map classes is provided below. In this example, the object references are stored in files in the current directory. For the purpose of maintaining symmetry with respect to how the object references are retrieved, additional methods are used to save the object references. This is optional, however, one should keep in mind that whichever way the object references are saved, the server map does the opposite to retrieve them.

The above description merely provides a disclosure of particular embodiments of the invention and is not intended for the purposes of limiting the same thereto. As such, the invention is not limited to only the above-described embodiments. Rather, it is recognized that one skilled in the art could conceive alternate embodiments that fall within the scope of the invention.

1. A method of developing one or more application programs that cooperate to manage a distributed system comprising one or more servers, wherein at least one application program is associated with each server, the method including the steps:
a) defining one or more managed objects associated with the distributed system in an object-oriented resource definition language and storing the definition of the one or more managed objects in one or more resource definition language files, wherein the definition of the one or more managed objects is based on an existing design and hierarchical structure of the distributed system, wherein parent-child relationships between the one or more managed objects are identified in the one or more resource definition language files using the object-oriented resource definition language to define the one or more managed objects in relation to the hierarchical structure of the distributed system;
b) parsing the one or more resource definition language files to ensure conformity with the object-oriented resource definition language and creating an intermediate representation of the distributed system from the one or more conforming resource definition language files;
c) processing the intermediate representation of the distributed system to form one or more programming language classes, one or more database definition files, and one or more script files;
d) providing a reusable asset center framework to facilitate development of the one or more application programs, the reusable asset center including a distribution adaptor framework that provides each application program with distribution transparency for remote and local operations associated with the one or more servers; and
e) building the one or more application programs from at least the one or more programming language classes, one or more database definition files, one or more script files, and the reusable asset framework.

2. The method as set forth in claim 1 wherein the distributed system is a network.

3. The method as set forth in claim 2 wherein the network is a telecommunication network.

4. The method as set forth in claim 1 wherein the distribution adaptor framework is an adaptation layer framework.

5. The method as set forth in claim 1 wherein the distributed system includes one or more clients and at least one application program is associated with each client, wherein the distribution adaptor framework provides a pattern for utilizing client and server object proxies between applications programs associated with previously selected client/server pairs.

6. The method as set forth in claim 1 wherein the building step forms distribution adaptor code with one or more programming language classes.

7. The method as set forth in claim 6 wherein the distribution adaptor code includes at least one of a top object class, a client proxy class, a service proxy factory class, and a proxy finder class.

8. The method as set forth in claim 7 wherein the top object class is a base class for the distribution adaptor code.

9. The method as set forth in claim 7 wherein the distributed system includes one or more clients and at least one application program is associated with each client, wherein the client proxy class provides distribution abstraction to application programs associated with the one or more clients.

10. The method as set forth in claim 7 wherein the service proxy factory class is used to specify each client and server instance of the distributed system in a factory collection.

11. The method as set forth in claim 10 wherein the proxy finder class is used to find a selected client or server instance from the factory collection.

12. The method as set forth in claim 1 wherein the reusable asset framework is reusable with respect to development of another application program for another distributed system.

13. The method as set forth in claim 12 wherein the distribution adaptor framework is reusable with respect to development of another application program for another distributed system.

14. The method as set forth in claim 1 wherein the distributed system includes one or more clients and at least one application program is associated with each client, wherein communications between at least one application program associated with a server and at least one application associated with a client are via at least one of CORBA and TCP/IP.

15. A method of developing one or more application programs in operative communication to manage a network including one or more servers, wherein at least one application program is associated with each server, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network created in the parsing step includes a parse tree;
c) processing the parse tree to form one or more programming language classes, wherein the one or more programming language classes formed include at least one of one or more system classes, one or more module classes, one or more managed object classes, and one or more composite attribute classes;
d) providing a reusable asset center framework to facilitate development of the one or more application programs, the reusable asset center including a distribution adaptor framework that provides each application program with distribution transparency for remote and local communications for the server with which the application program is associated; and
e) building the one or more application programs from at least the one or more programming language classes and the reusable asset framework.

16. The method as set forth in claim 15 wherein the network is a telecommunication network.

17. The method as set forth in claim 15 wherein the distribution adaptor framework is an adaptation layer framework.

18. The method as set forth in claim 15 wherein the network includes one or more clients and at least one application program is associated with each client, wherein the distribution adaptor framework provides a pattern for utilizing client and server object proxies between applications programs associated with previously selected client/server pairs.

19. The method as set forth in claim 15 wherein the building step forms distribution adaptor code with one or more programming language classes.

20. The method as set forth in claim 15 wherein the reusable asset framework is reusable with respect to development of another application program for another network.

21. The method as set forth in claim 1 wherein the network includes one or more clients and at least one application program is associated with each client, wherein communications between at least one application program associated with a server and at least one application associated with a client are via CORBA or TCP/IP.

22. A method of developing an application program to manage a network, the method including the steps:
a) defining one or more managed objects associated with the network in an object-oriented resource definition language and storing the definition of the one or more managed objects in one or more resource definition language files, wherein the definition of the one or more managed objects is based on an existing design and hierarchical structure of the network, wherein parent-child relationships between the one or more managed objects are identified in the one or more resource definition language files using the object-oriented resource definition language to define the one or more managed objects in relation to the hierarchical structure of the network;
b) parsing the one or more resource definition language files to ensure conformity with the object-oriented resource definition language and creating an intermediate representation of the network from the one or more conforming resource definition language files, wherein the intermediate representation of the network includes object meta-data;
c) processing the object meta-data to form one or more programming language classes, one or more database definition files, and one or more script files, wherein the one or more programming language classes formed include at least one of an index class and a query class;
d) providing a reusable asset center framework to facilitate development of the application program, the reusable asset center including a distribution adaptor framework that provides the application program with distribution transparency for remote and local operations; and
e) building the application program from at least the one or more programming language classes, one or more database definition files, one or more script files, and the reusable asset framework.

23. The method as set forth in claim 22 wherein the network is a telecommunication network.

24. The method as set forth in claim 22 wherein the distribution adaptor framework is an adaptation layer framework.

25. The method as set forth in claim 22 wherein the building step forms distribution adaptor code with one or more programming language classes.

26. The method as set forth in claim 22 wherein the reusable asset framework is reusable with respect to development of another application program for the same network.
